(19) United States
(12) Patent Application Publication
(10) Pub. No.: US 2004/0111336 A1
(43) Pub. Date: Jun. 10, 2004

(54) Method, system, and storage medium for optimizing procurement and fulfillment processes over a computer network

(75) Inventors: David D. Argust, Kingston, NY (US); Bernard B. McAvoy, Poughkeepsie, NY (US)

Correspondence Address: Philmore H. Colburn II, CANTOR COLBURN LLP, 55 Griffin Road South, Bloomfield, CT, 06002, US

(73) Assignee: International Business Machines Corporation, Armonk, NY

(21) Appl. No.: 10/316,685

(22) Filed: Dec. 10, 2002

(51) Int. Cl. G06F 17/60

(52) U.S. Cl. 705/28

(57) ABSTRACT

The method comprises receiving a change request to a pending customer order via the computer network. The change request comprises a latest acceptable delivery date and at least one of: a requested delivery date different from a delivery date specified in the pending customer order; a quantity of an item different from a quantity specified in the pending customer order; and a new item and desired quantity of said item, the new item not specified in the pending customer order. The method also comprises processing the change request and transmitting either: a confirmation message approving the change request if the latest acceptable delivery date can be met, or a capability response of the latest acceptable delivery date cannot be met. If a capability response is transmitted, the original terms provided in the pending customer order remain intact. Other embodiments include a system and a storage medium.

### BACKGROUND

This invention relates generally to customer ordering and fulfillment activities, and more particularly, the present invention relates to a method, system, and storage medium for optimizing customer sales and delivery activities over a computer network.

Electronic procurement relates to the business-to-business purchase and sale of goods and services over an electronic network. Electronic procurement activities are becoming increasingly mainstreamed into modern day business practices in an effort to automate and better control inventories, overhead costs, and improve manufacturing processes. Procurement activities conducted over a computer network can be a formidable experience for buyers who repeatedly, or even occasionally, find themselves in a situation where a pending order requires modification due to factors such as unexpected changes in market conditions and economic influences. When a customer desires to change an existing order in an e-business environment, it is often the case that the original delivery date previously agreed upon is adversely affected. Upon the submission of a new order, the customer typically receives a scheduled delivery date.

If the customer later attempts to modify the order in the form of adding or removing items, a new scheduled delivery date usually results. This new date may be earlier or later than the previously provided scheduled delivery date, depending upon the product availability of the order. When ordering groups of products, configurable products, or systems that have associated delivery group requirements, the chances are increased that the supply of the item will be constrained, affecting the entire order. In many cases, the customer's expectation is that the alteration will have little or no affect upon the delivery date. Where items are removed from the order, the customer's expectation may be for an improvement, viz-a-viz, earlier scheduled delivery date. However, if the new date does not meet the customer's expectation, as is generally the case with later delivery dates, the customer may prefer to retain the original order content and scheduled delivery date.

From the standpoint of the supplier enterprise, there are considerable complexities and costs associated with maintaining supply for both orders until a customer decides which option is preferred. Many times a real-time decision maker will not be present at the time that the alteration request is submitted.

What is needed, therefore, is a system and method for optimizing product ordering and fulfillment activities over a computer network that can handle changing requirements to purchase orders by a customer base.

### SUMMARY

The method comprises receiving a change request to a pending customer order via the computer network. The change request comprises a latest acceptable delivery date and at least one of: a requested delivery date different from a delivery date specified in the pending customer order; a quantity of an item different from a quantity specified in the pending customer order; and a new item and desired quantity of said item, the new item not specified in the pending customer order. The method also comprises processing the change request and transmitting either: a confirmation message approving the change request if the latest acceptable delivery date can be met, or a capability response if the latest acceptable delivery date cannot be met. If a capability response is transmitted, the original terms provided in the pending customer order remain intact. Other embodiments include a system and a storage medium.

### BRIEF DESCRIPTION OF THE DRAWINGS

Referring now to the drawings wherein like elements are numbered alike in the several FIGURES:

FIG. 1 is a block diagram of a system for implementing the conditional order alteration tool in an exemplary embodiment;

FIG. 2 is a flowchart illustrating the process of implementing a conditional change request via the tool in an exemplary embodiment;

FIG. 3 is a sample computer screen window illustrating a web page and menu items for accessing the conditional order alteration tool in an exemplary embodiment;

FIG. 4 is a sample change request form as seen by a customer via a graphical user interface provided by the conditional order alteration tool in an exemplary embodiment;

FIG. 5 is a sample computer screen window presented by the conditional order alteration tool for instructing a customer in implementing a change to an existing order in an exemplary embodiment;

FIG. 6 is a sample computer screen window presented by the conditional order alteration tool illustrating a successful change order request; and

FIG. 7 is a sample computer screen window presented by the conditional order alteration tool illustrating an unsuccessful change order request including alternative options.

### DESCRIPTION OF THE PREFERRED EMBODIMENT

The conditional order alteration tool of the invention enables customers to implement a transaction that is conditioned on the seller meeting the latest acceptable arrival date specified on the change request form by the customer.

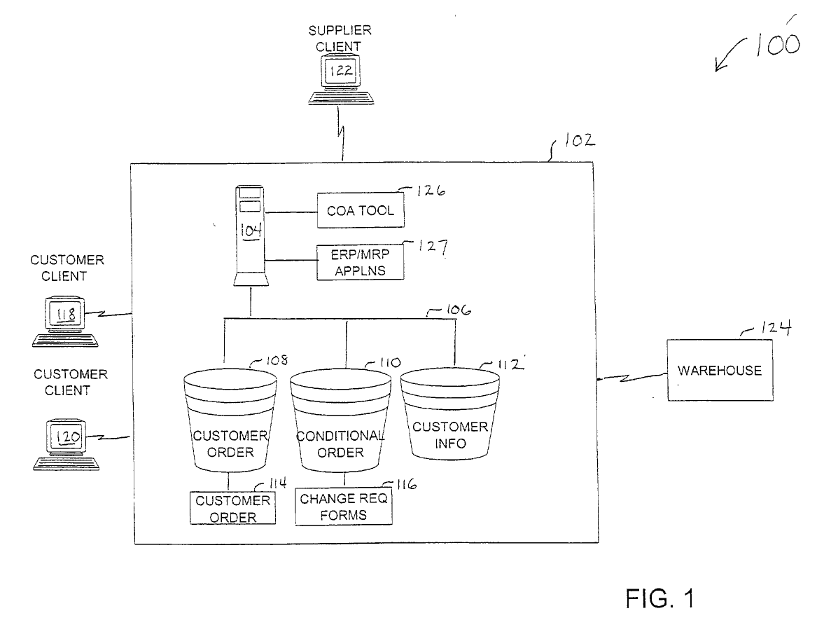

In an exemplary embodiment, the conditional order alteration tool 126 is implemented via a networked system such as that depicted in FIG. 1. System 100 may be part of a wide area network including multiple geographical locations that are interconnected by high-speed data lines or radio links. In the simplified diagram of FIG. 1, system 100 represents an extended enterprise including a business enterprise 102, a remote warehouse 124, a supplier client 122, and customer clients 118 and 120. The conditional order alteration tool 126 of system 100 operates in a client/server architecture mode via a server 104, a network 106, databases 108-112, a supplier client 122, customer clients 118-120, and warehouse 124.

Server 104 is associated with databases 108-112 and allows customer clients 118-120 to access information stored therein. Customer clients 118-120 represent computer workstations operated by purchasing agents of customers doing business with business enterprise 102. Purchasing agents are typically procurement specialists who buy goods from business enterprise 102 and, though not necessary to realize the advantages of the invention, they may be subject to a contractual agreement with business enterprise 102. Supplier client 122 represents a computer workstation operated by an individual of a supplier entity doing business with business enterprise 102. A supplier entity refers to a vendor of materials, parts, assemblies, etc., from which business enterprise 102 procures goods. For example, if business enterprise 102 manufactures computers, then a typical supplier client 122 of business enterprise 102 may be a vendor of semiconductor materials, a power supply manufacturer, or a software vendor.

It should be noted that any number of customer clients and supplier clients may be engaged in the purchasing and sales activities with business enterprise 102 and managed by the conditional order alteration tool 126. For purposes of illustration, however, only two customer clients 118-120 and one supplier client 122 are shown. Each of customer clients 118-120 and supplier client 122 may comprise a web-enabled personal computing device such as a desktop, laptop, or other similar apparatus known in the art. Further, the term “business enterprise” refers to the organization implementing the conditional order alteration tool 126 of the invention.

Network 106 may comprise a LAN, a WAN, or other network configuration known in the art. Network 106 may include wireless technology, radio-based communications, telephony-based communications, or a combination of the above. For purposes of illustration, however, network 106 is a LAN Intranet. Access is limited to internal devices and applications through a firewall or similar security system (not shown) which protects system 100 from unauthorized access. The business enterprise preferably executes suitable multi-platform supported server software for creating secure, interactive Internet, Intranet, and Extranet applications, and which allows information stored in server 104 to be managed and presented to end users such as customer clients 118-120 and supplier client 122 via business applications utilizing data management components (e.g., IBM's DB2™) as well as a presentation component (e.g., Lotus Domino™). System 100 executes the conditional order alteration tool 126, among other applications via server 104, customer clients 118-120, or a combination of the above. Server 104 preferably executes a suite 127 comprising an enterprise resource planning (ERP) software application and materials requirements planning (MRP) software application. Server 104 allows business enterprise 102 to maintain up-to-date information about customer orders, change requests, and general procurement activities in a real-time environment through its replication features and web browsers. Server 104 shares information with customer clients 118-120, storing the most current data for access by user systems.

Customer clients 118-120 and supplier client 122 may access server 104 via collaboration, application/data sharing, or standard web browsers (e.g. Lotus NoteS™ compliant software, HTML based or Java enabled web applications, etc.) located on these client systems. Software may be Lotus NoteS™ although it is not necessary in order to realize the advantages of the present invention.

Internal data storage of server 104 may comprise any form of mass storage device configured to read and write database type data maintained in a file store (e.g., a magnetic disk data storage device) and is logically addressable as a consolidated data source across a distributed environment such as system 100. The implementation of local and wide-area database management systems to achieve the functionality of the storage element will be readily understood by those skilled in the art.

Customer order database 108 stores pending orders for goods placed by customer clients 118 and 120. These orders are submitted via customer order forms 114. A typical completed customer order form 114 contains a variety of information regarding the customer and the particular order such as a customer name, customer code or identifier, a name and description of the item(s) ordered, part or catalog numbers relating to the items if applicable, the quantity of each item desired, pricing information, and a scheduled shipping or delivery date. Customer order forms 114 preferably include some unique identification that will allow the order to be mapped to a completed “change request form” 116 (also referred to herein as conditional change request and conditional alteration request) should a customer desire to alter the order at a later point in time.

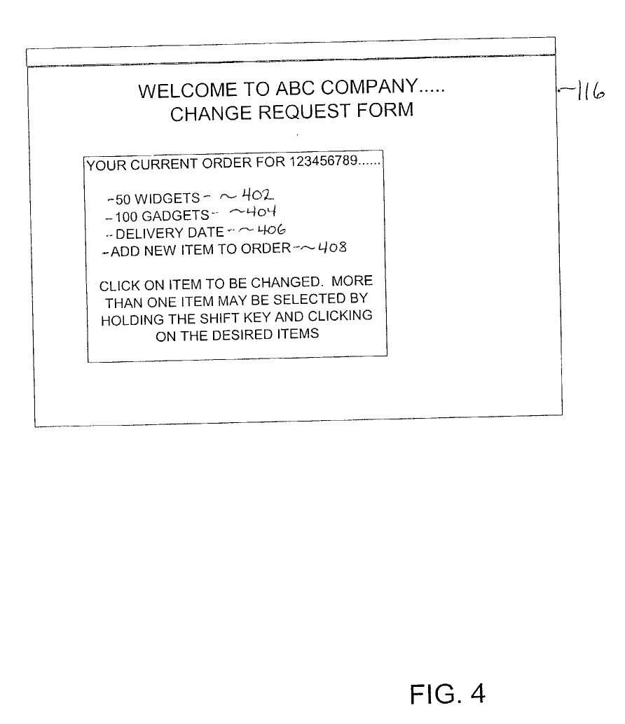

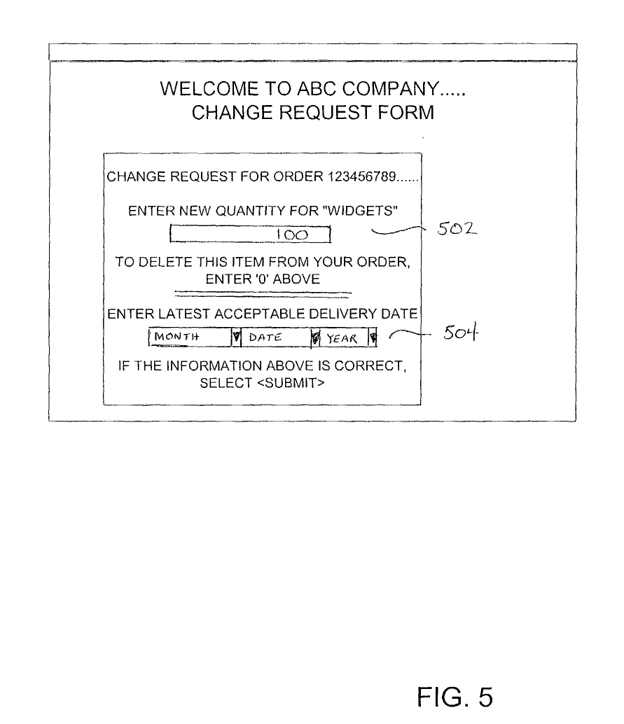

Conditional order alteration database 110 provides the customer community with an online change request form 116 to initiate any requests to modify existing orders. Conditional order alteration database 110 stores change requests for pending customer orders for which the respective customers desire to modify one or more of the terms supplied in the original order. A sample uncompleted change request form 116 is illustrated in FIG. 4. The change request form 116 of FIG. 4 displays existing order items with instructions on how to request a change. Information provided in change request form 116 includes a unique identifier 401 or order reference number that is capable of linking the completed change request form to the original completed customer order form 114. A partially completed change request form 116 is provided in FIG. 5. Change request form 116 also includes a feature used by the conditional order alteration tool 126 that allows business enterprise 102 to provide responses to these requested changes. A response can include an affirmation that the change is approved, a rejection or denial of the change, and alternative suggestions for the customer such as modified delivery dates and partial shipments of goods. Likewise, this response feature also includes a space where the customer can initiate a second conditional alteration request using the alternative date provided by business enterprise 102 as the latest acceptable delivery date. Sample responses to a completed change request form 116 is illustrated in FIGS. 7 and 7.

Customer information database 112 manages information regarding existing and new customers such as address, contact information, payment terms, contract details, data relating to past purchase activities, etc.

The conditional order alteration tool 126 provides the functionality for automated and/or semi-automated approval routing whereby changes to delivery dates for orders as well as quantities can be evaluated and effectuated according to customer preferences and known business capabilities. Within this system, a small group of individuals may become involved as needed to review activities and complete any administrative work associated with them.

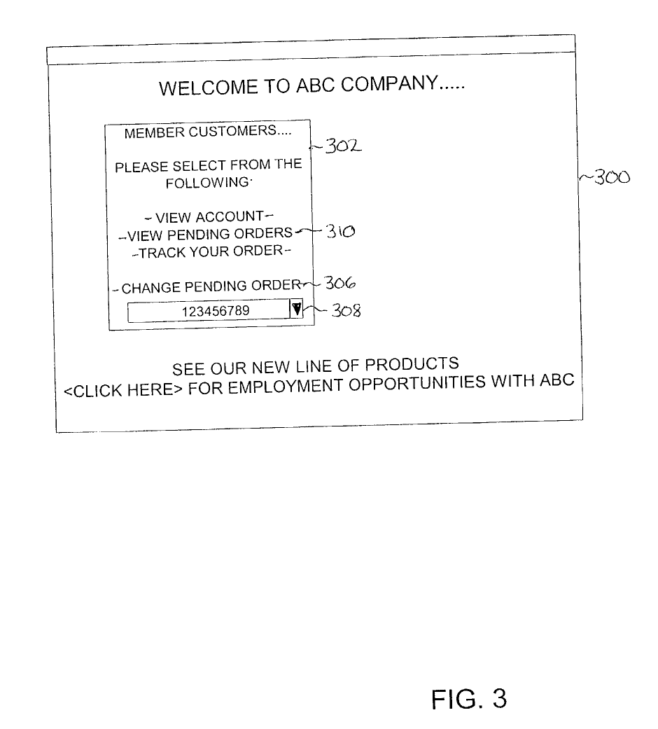

The conditional order alteration tool 126 includes a user interface for allowing customers with access permissions to the tool 126 via business enterprise 102 web site capabilities to view existing orders, customer account information, track deliveries, and change pending orders. These capabilities are presented via a menu illustrated in FIG. 3.

While the system of FIG. 1 has been described with respect to a client/server architecture network with the conditional order alteration application executing on server 104 and client systems 118-122 acting primarily as dumb clients, it will be understood to those skilled in the art that the system and method of the invention may be implemented in business-to-business environment wherein one or more of client systems 118-122 execute the conditional order alteration tool 126 along with associated client-side ERP applications.

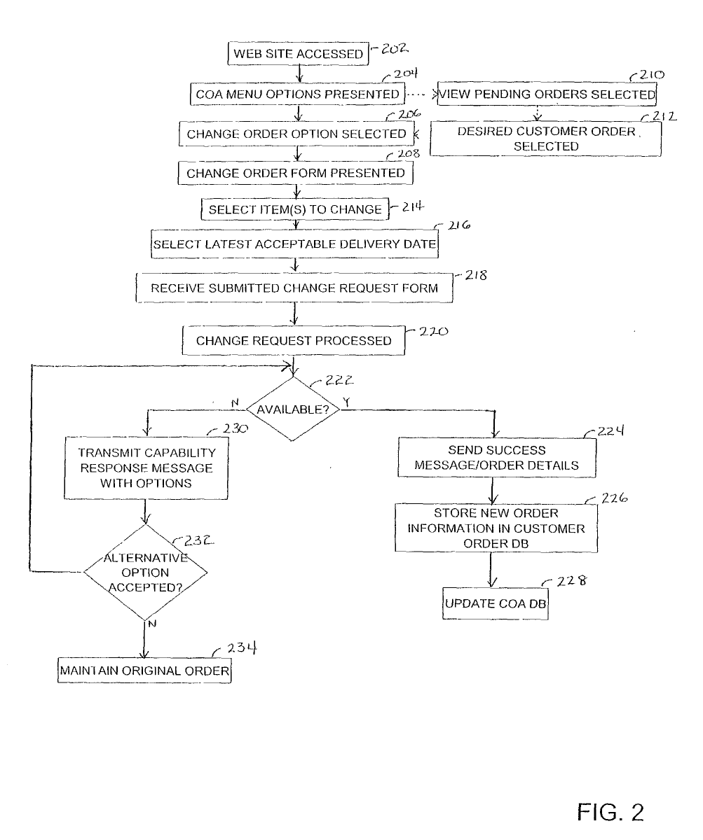

A framework for the flow of information associated with the implementation of the tool 126 is described in FIG. 2. This process assumes that an existing customer order (also referred to herein as a purchase order) is pending in the system and stored in customer order database 108.

The web site of business enterprise 102 is accessed by a customer at one of customer clients 118, 120 at step 202. The web site includes an area 302 within the web site's main page or a link to a separate web page for customers as shown in computer screen window 300 of FIG. 3. This area 302 displays menu options selectable by the customer at step 204. A customer who wishes to submit a change to an existing order is prompted to select the “change pending order” option 306 at step 206. This can be accomplished by entering in the unique order reference number in box 308 which causes the conditional order alteration tool 126 to retrieve the pending customer order stored in customer order database 108. Other methods of specifying the order may be provided as well. A change request form 116 is displayed on the customer's computer screen window at step 208 and as shown in FIG. 4.

Alternatively, a customer viewing the menu options presented at step 204 selects “view pending orders” 310 at step 210. All pending orders are listed for the customer along with their reference numbers. The customer can then select the desired customer order according to the order reference number provided at step 212. The process continues at step 206 where the customer is prompted to select “change pending order” 306 which causes the conditional order alteration tool 126 to retrieve and present the change request form 116 as shown in FIG. 4.

The customer selects the item from the order that should be changed at step 214. This can be a new quantity of an ordered item 402, 404, a deletion of an item 402, 404, a change in delivery date 406, or a combination of the above. The customer may also add a new item to the order by selecting “add new item to order” 408. In the example change request 116 of FIG. 4, the customer has selected “widgets” 402. The conditional order alteration tool 126 then displays a new screen 500 of FIG. 5 for change request form 116 and the customer is prompted to enter a new quantity of widgets 502. The tool 126 prompts the customer to enter a latest acceptable delivery date 504 for the order at step 216. This is the latest possible date that the customer is willing to accept delivery of the goods. Upon receiving the request at step 218, the conditional order alteration tool 126 processes the changes according to the nature of the request at step 220. This step provides for an evaluation of one or more resources of the business enterprise 102. For example, the tool 126 may access information in the business enterprise inventory databases, or contact warehouse 124 to see if sufficient quantities of the ordered item are in stock and uncommitted to another customer. The tool 126 may further contact supplier client 122 to see if this item can be available by a specified date. Another type of change request may involve a request for an earlier delivery date. The process is substantially the same in that the tool 126 accesses the appropriate databases and/or resources to determine capabilities of the business enterprise in terms of satisfying the change in delivery date. Coordinating a portion of these activities can be accomplished with the assistance of the ERP application 127 utilized by business enterprise 102.

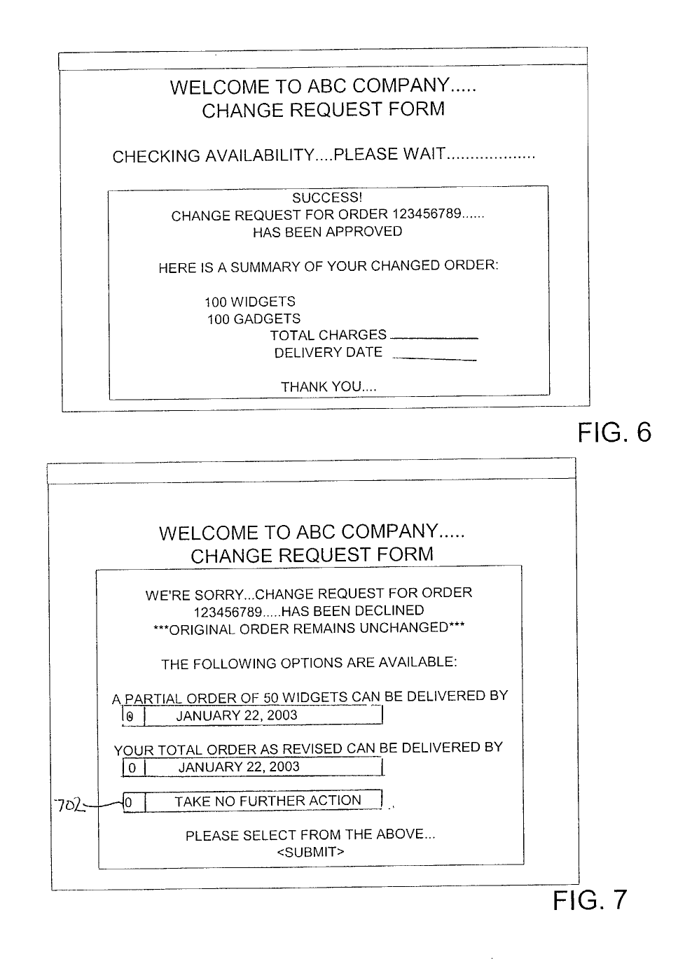

If the business enterprise is capable of complying with the new terms 502, 504 provided in the completed change request form of FIG. 5 at step 222, the tool 126 sends a confirmation message along with the revised and approved order details at step 224 as shown in FIG. 6. This new information is then updated in customer order database 108 at step 226 awaiting execution. The approved change request form 116 is stored in database 110 for reporting activities and administrative purposes at step 228.

If the business enterprise is not capable of complying with the new terms 502, 504 provided in the completed change request form of FIG. 5 at step 222, the tool 126 transmits a capability response message to the customer along with alternative options at step 230 as shown in FIG. 7. A capability response may indicate an earliest possible date that the goods can be shipped or may indicate that a portion of the order is available for shipping on the earlier date. The capability response notice provides the customer at client system 118 with options. The original order is still in place at this time and no further action is required to be taken by the customer. However the customer may select one of the options presented in the response for resubmission as a new conditional alteration request. If the customer selects one of the options presented at step 232, this will result in either a confirmation message or a second capability response message (at steps 230 or 224) to the customer. This depends upon the enterprise's capability of delivering on this second request. For example, it is possible that in the intervening time period between the original response and the resubmission, the ability to deliver has changed. In other words, the desire to alter the original completed customer order 114 is conditioned upon the business' ability to satisfy the requirements of the completed change request form 116. If the customer does not accept one of the alternative options at step 232, or alternatively, selects “take no further action” 702, then the original order is maintained and executed at step 234.

As can be seen, the conditional order alteration system provides a mechanism for ensuring customer satisfaction throughout the procurement and delivery processes with the added benefit of flexibility in negotiating changes and proposed changes to existing customer orders.

As described above, the present invention can be embodied in the form of computer-implemented processes and apparatuses for practicing those processes. The present invention can also be embodied in the form of computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. The present invention can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While preferred embodiments have been shown and described, various modifications and substitutions may be made thereto without departing from the spirit and scope of the invention. Accordingly, it is to be understood that the present invention has been described by way of illustration and not limitation.

1. A method for optimizing procurement and fulfillment processes over a computer network, comprising:
receiving a change request to a pending customer order via said computer network, said change request comprising a latest acceptable delivery date and at least one of:
a requested delivery date different from a delivery date specified in said pending customer order;
a quantity of an item different from a quantity specified in said pending customer order; and
a new item and desired quantity of said item, said new item not specified in said pending customer order;
processing said change request; and
according to results of said processing, transmitting at least one of:
a confirmation message approving said change request if said latest acceptable delivery date can be met; and
a capability response if said latest acceptable delivery date cannot be met, wherein terms provided in said pending customer order remain intact.

2. The method of claim 1, further comprising:
receiving a second change request in response to said capability response, said second change request prompted by alternative options provided in said capability response;
processing said second change request; and
according to results of said processing, transmitting at least one of:
a confirmation message approving said second change request if an alternative option selected in said capability response can be met; and
a second capability response if said alternative option selected in said capability response cannot be met, wherein terms provided in said pending customer order remain intact.

3. The method of claim 2, wherein said alternative options provided in said capability response include at least one of:
a proposed delivery date; and
a proposal to deliver a partial shipment of one or more items specified in said change request.

4. The method of claim 1, wherein said terms provided in said pending customer order are changed if said latest acceptable delivery date can be met.

5. The method of claim 2, wherein said terms provided in said pending customer order are changed if an acceptance of said alternative option selected in said capability response is received and if said alternative option selected can be met.

6. The method of claim 1, wherein said processing said change request includes at least one of:
examining inventory levels for items in said change request;
evaluating resources available for executing said change request;
contacting a supplier entity for determining item availability; and
reviewing storage facilities warehousing for items in said change request.

7. The method of claim 2, wherein said processing said change request includes at least one of:
examining inventory levels for items in said second change request; evaluating resources available for executing said second change request;
contacting a supplier entity for determining item availability; and
reviewing storage facilities warehousing for items in said second change request.

8. A storage medium encoded with machine-readable computer program code for optimizing procurement and fulfillment processes over a computer network, said storage medium including instructions for causing said computer network to implement a method comprising:
receiving a change request to a pending customer order via said computer network, said change request comprising a latest acceptable delivery date and at least one of:
a requested delivery date different from a delivery date specified in said pending customer order;
a quantity of an item different from a quantity specified in said pending customer order; and
a new item and desired quantity of said item, said new item not specified in said pending customer order;
processing said change request; and
according to results of said processing, transmitting at least one of:
a confirmation message approving said change request if said latest acceptable delivery date can be met; and
a capability response if said latest acceptable delivery date cannot be met, wherein terms provided in said pending customer order remain intact.

9. The storage medium of claim 8, further comprising instructions for causing said computer to implement:
receiving a second change request in response to said capability response, said second change request prompted by alternative options provided in said capability response;
processing said second change request; and
according to results of said processing, transmitting at least one of:
a confirmation message approving said second change request if an alternative option selected in said capability response can be met; and
a second capability response if said alternative option selected in said capability response cannot be met, wherein terms provided in said pending customer order remain intact.

10. The storage medium of claim 9, wherein said alternative options provided in said capability response include at least one of:
a proposed delivery date; and
a proposal to deliver a partial shipment of one or more items specified in said change request.

11. The storage medium of claim 8, wherein said terms provided in said pending customer order are changed if said latest acceptable delivery date can be met.

12. The storage medium of claim 9, wherein said terms provided in said pending customer order are changed if an acceptance of said alternative option selected in said capability response is received and if said alternative option selected can be met.

13. The storage medium of claim 8, wherein said processing said change request includes at least one of:
examining inventory levels for items in said change request;
evaluating resources available for executing said change request;
contacting a supplier entity for determining item availability; and
reviewing storage facilities warehousing for items in said change request.

14. The storage medium of claim 9, wherein said processing said change request includes at least one of:
examining inventory levels for items in said second change request;
evaluating resources available for executing said second change request;
contacting a supplier entity for determining item availability; and
reviewing storage facilities warehousing for items in said second change request.

15. A system for optimizing procurement and fulfillment processes over a computer network comprising:
a server including internal storage, said internal storage housing:
a customer order database;
a conditional order database; and
a customer information database;
a conditional order alteration tool executing on said server;
at least one customer client in communication with said server via said computer network;
at least one supplier client in communication with said server via said computer network and a warehouse in communication with said server via said computer network.

16. The system of claim 15, wherein said customer order database stores pending customer orders, said pending customer orders including:
a description of an item ordered;
a quantity of an item ordered; and
a requested delivery date.

17. The system of claim 16, wherein said customer orders are created online over said computer network via customer order forms.

18. The system of claim 15, wherein said conditional order database stores change requests, said change requests including at least one of:
a delivery date different from a delivery date specified in said customer order;
a quantity different from a quantity specified in said customer order; and
a desired item not specified in said customer order.

19. The system of claim 18, wherein said delivery date different from said delivery date specified in said customer order is a latest acceptable date that delivery of items specified in said change request can be delivered.

20. The system of claim 15, wherein said server executes at least one of:
an enterprise resource planning application; and
a materials requirement planning application.

21. The system of claim 16, wherein terms provided in said customer order are unchanged in said customer order database until confirmation and acceptance of said change request is received.
